(19) United States
(12) Patent Application Publication
(10) Pub. No.: US 2006/0119267 A1
(43) Pub. Date: Jun. 8, 2006

(54) Plasma display panel

(76) Inventors: Seung-Uk Kwon, Suwon-si (KR); Kyoung-Doo Kang, Suwon-si (KR)

Correspondence Address: H.C. PARK & ASSOCIATES, PLC, 8500 LEESBURG PIKE, SUITE 7500, VIENNA, VA, 22182, US

(21) Appl. No.: 11/272,076

(22) Filed: Nov. 14, 2005

(30) Foreign Application Priority Data
Nov. 13, 2004 (KR) 10-2004-0092771

(51) Int. Cl. H01J 17/49

(52) U.S. Cl. 313/582

(57) ABSTRACT

Provided is a plasma display panel with unit pixels, each of which is formed of a red, green, and blue sub-pixel and an additional sub-pixel of the light having the lowest maximum brightness level. The phosphor layers in the two sub-pixels with the lowest maximum brightness level are selected so the first of the two phosphor layers has a higher brightness level than the second layer, while the second layer has a longer life span property than the first. As a result, the maximum brightness, and the color temperature of the unit pixel, and life span properties are improved over the conventional plasma display panel.

### CROSS REFERENCE TO RELATED APPLICATIONS

This application claims priority to and the benefit of Korean Patent Application No. 10-2004-0092771, filed on Nov. 13, 2004, in the Korean Intellectual Property Office, which is hereby incorporated by reference for all purposes as if fully set forth herein.

### BACKGROUND OF THE INVENTION

1. Field of the Invention

The present invention relates to a plasma display panel with an improved structure capable of increasing color temperature property and brightness maintaining function.

2. Discussion of the Background

In a plasma display panel, a glow discharge is generated by applying a predetermined voltage to electrodes installed in a sealed space, where a gas is filled between the electrodes. A phosphor layer lines the bottom and sides of the sealed space, and when the gas is excited by discharge between the electrodes, it releases ultraviolet rays that collide with the phosphor layer. The ultraviolet rays excite the phosphors, which give off visible light photons of a predetermined color to display an image.

The plasma display panel can be classified into direct current (DC) type, alternating current (AC) type, and a hybrid type plasma display panel according to the driving method. In addition, the plasma display panel also can be classified into two-electrode type and three-electrode type according to the structure of electrodes. The DC plasma display panel includes an auxiliary electrode for inducing an auxiliary discharge, and the AC plasma display panel includes an address electrode to improve addressing speed by dividing an address discharge from a sustain discharge. In addition, the AC plasma display panel can be classified into an opposing discharge type and a surface discharge type according to arrangement of the electrodes performing the discharge. The opposing discharge type includes two sustain electrodes disposed on opposite substrates to generate the discharge perpendicularly to the panel. The surface discharge type includes two sustain electrodes that are disposed on a same substrate to generate the discharge in the plane of the substrate.

FIG. 1 is a cross-sectional view of a sub-pixel formed in a conventional surface discharge type three-electrode structure plasma display panel.

Referring to FIG. 1, in a sub-pixel 10, a pair of sustain electrodes 12 including a common electrode 13 and a scan electrode 14, which are separated from each other to form discharge gaps, are formed on a lower surface of an upper substrate 11. The common and scan electrodes 13 and 14 respectively include transparent electrodes 13a and 14a and bus electrodes 13b and 14b formed on lower surfaces of the transparent electrodes 13a and 14a to apply voltages. The pair of sustain electrodes 12 is embedded in an upper dielectric layer 15, and a protective layer 16 is formed under the upper dielectric layer 15.

In addition, a lower substrate 21 faces the upper substrate 11, and an address electrode 22 is formed on the lower substrate 21. The address electrode 22 is embedded in a lower dielectric layer 23. In addition, barrier ribs 24 are formed on the lower dielectric layer 23, and a phosphor layer 25 is formed in a space defined by the barrier ribs 24. A discharge gas is injected into the cells between the barrier ribs 24 and phosphor layers 25 of the sub-pixel 10 having the above structure.

A plasma display panel containing the sub-pixels 10 of the above structure operates as described below.

When an address voltage is applied between the address electrode 22 and the scan electrode 14, an address discharge occurs, and accordingly, wall charges accumulate in the addressed sub-pixel 10. In addition, a sustain voltage is applied between the common electrode 13 and the scan electrode 14 to generate sustain discharge. The electric charges generated by the discharge collide with the discharge gas to form plasma. Ultraviolet rays, generated by the plasma, excite the phosphor layer 25 which then emits visible lights to display an image.

One each of red, green, and blue color phosphor layers is disposed in the sub-pixel 10 for displaying colors, thus the sub-pixels 10 can be divided into red sub-pixels 10R, green sub-pixels 10G, and blue sub-pixels 10B as shown in FIG. 2. Three sub-pixels, one sub-pixel of each color red, green, and blue 10R, 10G, and 10B, form a unit pixel 30, and various colors can be displayed by combining the three primitive colors. Brightnesses of the red, green, and blue lights emitted from the red, green, and blue sub-pixels 10R, 10G, and 10B are each divided into 256 grades. The combination of 256 possible grades of brightness for each of the three sub-pixels means that there are 16,770,000 possible colors can be displayed from every unit pixel 30.

However, under conventional conditions, the maximum brightness level of the green light is the highest, and the maximum brightness level of blue light is the lowest. Since the blue light has the lowest maximum brightness level, a color temperature of white light that is represented by mixing the maximum brightness of each of the three sub-pixels is low, and the maximum brightness of the combined light is lowered. In addition, it is not easy to divide the brightness of the blue light into plural gradation levels, and thus, displaying capacity of the gradation levels is lowered.

To account for the lower maximum brightness of the blue sub-pixel, a second blue color sub-pixel can be added to the unit pixel 30. However, since the additional sub-pixel is added without increasing the size of the unit pixel 30, pitches between the red, green, and blue sub-pixels constituting the unit pixel 30 become narrower than in the conventional art. When the pitches between the sub-pixels become narrow, a capacitance of the unit pixel 30 increases, and thus the power consumption of the panel increases.

### SUMMARY OF THE INVENTION

This invention provides a plasma display panel capable of rising a color temperature and a brightness maintenance ratio of emitting light, by forming a unit pixel from four sub-pixels, wherein an additional sub-pixel is added for supplementing a sub-pixel having the lowest maximum brightness level.

Additional features of the invention will be set forth in the description which follows, and in part will be apparent from the description, or may be learned by practice of the invention.

The present invention discloses a plasma display panel comprising an upper substrate, a lower substrate, barrier ribs formed between the upper and lower substrates, red, green, and blue sub-pixels, on which red, green, and blue phosphor layers emitting red, green, and blue lights respectively are disposed, upper discharge electrodes and lower discharge electrodes that correspond to the sub-pixels, and unit pixels, each of which is formed by including the red, green, and blue sub-pixels and an additional sub-pixel of the light having the lowest maximum brightness level. Additionally, the phosphor layers disposed on the two sub-pixels with the lowest maximum brightness level have different brightness and life span properties from each other.

The present invention also discloses a plasma display panel comprising an upper substrate, a lower substrate, barrier ribs formed between the upper and lower substrates, red, green, and blue sub-pixels, on which red, green, and blue phosphor layers emitting red, green, and blue lights respectively are disposed, upper discharge electrodes and lower discharge electrodes that correspond to the sub-pixels, and unit pixels comprising red, green, and blue sub-pixels and an additional sub-pixel emitting red, green, or blue light.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a cross-sectional view of a sub-pixel according to the conventional art.

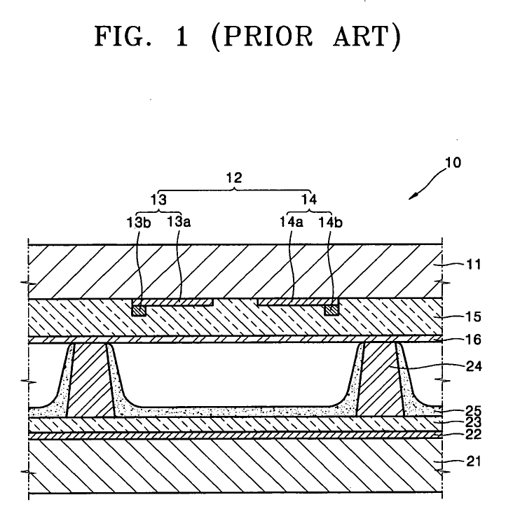

FIG. 2 shows a partial plan view of a unit pixel including sub-pixels of FIG. 1.

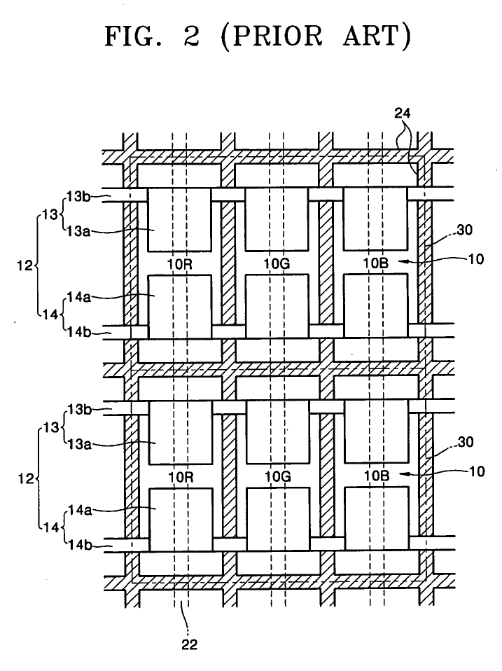

FIG. 3 shows a partial exploded perspective view of a plasma display panel according to an embodiment of the present invention.

FIG. 4 shows a cross-sectional view of the plasma display panel taken along line IV-IV of FIG. 3.

FIG. 5 shows a partial plan view of an arrangement of sub-pixels of FIG. 3 forming a unit pixel.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

In the following description and drawings, the same reference numerals are used to designate the same or similar components, so repetition of the description on the same components shall be omitted.

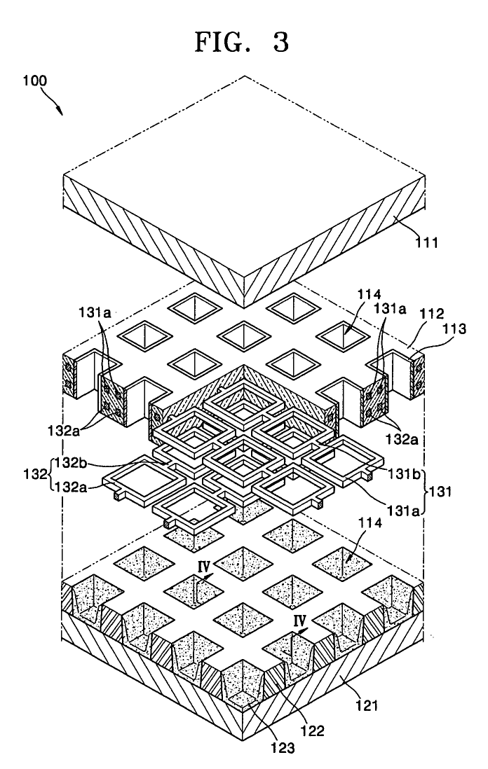

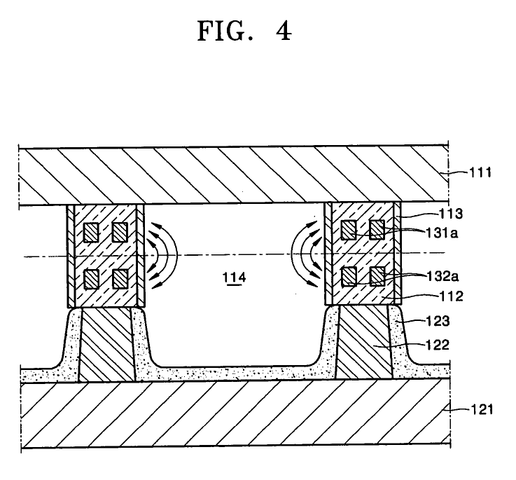

Referring to FIGS. 3 and 4, the plasma display panel 100 includes an upper substrate 111 and a lower substrate 121 facing the upper substrate 111 and coupled to the upper substrate 111.

The upper and lower substrates 111 and 121 are formed of any material, and the upper substrate 111 can possess a light permeability if an image is displayed through the upper substrate 111.

In addition, barrier ribs are disposed between the upper and lower substrates 111 and 121. Referring to the drawings, the barrier ribs include first barrier ribs 112 and second barrier ribs 122, which are formed in predetermined patterns, for example, with transverse cross sections formed as a matrix pattern. In addition, lower surface of the first barrier rib 112 corresponds to upper surface of the second barrier rib 122, and thus, spaces defined by the first barrier ribs 112 correspond to and match with spaces defined by the second barrier ribs 122. However, the first and second barrier ribs may be formed as closed type barrier ribs such as a waffle pattern, or formed to have transverse cross sections of polygonal shape such as triangle or pentagon, circular, or oval shape. Further, the first and second barrier ribs can be combined in various formations, for example, the first barrier rib can be formed as closed type while the second barrier rib is formed as open type such as stripe pattern. The first and second barrier ribs 112 and 122 can be formed separately, or integrally with each other. If these are separately formed, at least the first barrier ribs 112 are formed of dielectric material, and if these are formed integrally with each other, both of the first and second barrier ribs 112 and 122 are formed of the dielectric material.

The first and second barrier ribs 112 and 122 define sub-pixels 114 with the upper and lower substrates 111 and 121 and the upper and lower boundaries, respectively. The barrier ribs and substrates prevent cross talk from generating between the defined sub-pixels 114.

In each sub-pixel 114, a phosphor layer 123 is disposed. The phosphor layer is excited by ultraviolet rays generated during the sustain discharge and emits visible lights for display. As shown in FIG. 3, the phosphor layer 123 can be formed on the surface area of the second barrier rib 122 that comprises the sub-pixel 114. Specifically, phosphor layer 123 is shown as formed on upper surface of the lower substrate 121 and side surfaces of the second barrier rib 122.

Since the phosphor layer 123 is formed on the surface defined by the second barrier rib 122, it can be separated from the region of the sub-pixel 114 inside the first barrier rib 112 where the discharge occurs. Therefore, ion sputtering of the phosphor layer 123 by charged particles can be prevented, and thus, life span of the display panel can be increased. In addition, by separating the phosphor layer 123 from the discharge reduces the possibility of generating permanent image sticking on the display even when the same image is displayed for a long time. A discharge gas is filled in each sub-pixel 114 in which the phosphor layer 123 is disposed. The discharge gas may be a gas, for example, in which Xe generating ultraviolet rays and Ne functioning as a buffer are mixed.

As shown in FIG. 3, upper discharge electrodes 131 and lower discharge electrodes 132, which together generate discharge in the sub-pixels 114, are disposed in the first barrier ribs 112 and surround the perimeter of each sub-pixel 114, and are arranged to cross each other. The upper discharge electrodes 131 are disposed at upper portion adjacent to the first substrate 111, and the lower discharge electrodes 132 are disposed under the upper discharge electrodes 131. Alternatively, the upper discharge electrodes 131 may be disposed in the first barrier ribs 112 and the lower discharge electrodes 132 may be disposed in the second barrier ribs 122. Further, the upper and lower discharge electrodes 131 and 132 may be disposed in the second barrier ribs 122. The upper electrodes 131 and the lower electrodes 132 can be formed of conductive metal such as aluminium, copper, and silver, for example. Since the metal electrode has relatively lower resistance than the electrode formed of indium tin oxide (ITO), discharge response speed is faster than in the conventional plasma display panel, which uses the ITO electrodes.

The first barrier ribs 112 or the second barrier ribs 122 embed the upper or lower discharge electrodes 131 and 132 and are formed of dielectric material. Accordingly, direct electric conduct between the upper and lower electrodes 131 and 132 is avoided, and damage to the upper and lower discharge electrodes 131 and 132 due to direct collide of charged particles onto electrodes is avoided. In addition, it is easy to accumulate wall charges by inducing the charged particles. The first barrier ribs 112 or the second barrier ribs 122 which embed the upper or lower discharge electrodes 131 and 132 may be formed of such dielectric material as PbO, B₂O₃, or SiO₂.

A protective layer 113 of predetermined thickness is further formed on the side surfaces of the first barrier ribs 112. The protective layer may be, for example, MgO. When the protective layer 113 is formed, the direct contact of the charged particles generated during the discharge on the first barrier ribs 112 is prevented. Thus, damage to the first barrier ribs 112 due to ion sputtering of the charged particles is avoided. In addition, since the charged particles directly collide with the protective layer 113, MgO as the protective layer may emit secondary electrons that then contributing to the discharge Thus, the panel can be driven with lower voltage and the light emission efficiency can be improved.

The upper and lower discharge electrodes 131 and 132 disposed in the first barrier ribs 112 will be described in more detail as follows.

The upper discharge electrodes 131 disposed at upper portion inside the first barrier ribs 112 are separated from each other by predetermined intervals, and extend in a predetermined direction. Referring to FIG. 3, one upper discharge electrode 131 surrounds four sides of the perimeter of each sub-pixel 114 that is arranged along the extending direction of the upper discharge electrode 131. That is, each of the upper discharge electrodes 131 includes upper discharge units 131a surrounding each sub-pixel 114 to contribute to the discharge, and upper connection units 131b connecting each of the upper discharge units 131a.

Here, the upper discharge units 131a are formed as square bands having predetermined widths and disposed in the first barrier ribs 112, and accordingly, can surround the four sides comprising the perimeter of each sub-pixel 114. However, the upper discharge units 131a may be formed as several kinds of closed types such as waffle pattern, triangle or pentagon, circular or oval shape. Further, the upper discharge units 131a may be formed as several kinds of open types such as semi-waffle pattern, semi-triangle or pentagon, semi-circular of oval shape. In addition, the upper discharge electrodes 131 with the above described structures can be disposed in the same plane within the plasma display panel, and are separated from each other by a predetermined gap.

The lower discharge electrodes 132 disposed under the upper discharge electrodes 131 are separated from each other with predetermined intervals, and extend along a direction crossing the extending direction of the upper discharge electrodes 131. As shown in FIG. 3, like the upper discharge electrodes 131, one lower discharge electrode 132 surrounds the four sides comprising the perimeter of each sub-pixel 114 arranged along the extending direction of the lower discharge electrode 132. Therefore, each of the lower discharge electrodes 132 includes lower discharge units 132a arranged in a row and respectively surrounding each sub-pixel 114 to contribute to the discharge, and lower connection units 132b connecting each of the lower discharge electrodes 132a.

In FIG. 3, the lower discharge units 132a are formed as square bands having predetermined widths and disposed in the first barrier ribs 112, and accordingly, can surround the four sides comprising the perimeter of each sub-pixel 114. However, the lower discharge units 132a, like the upper discharge units 131a, may be formed as several kinds of closed types such as waffle pattern, triangle or pentagon, circular or oval shape. Further, the lower discharge units 132a may be formed as several kinds of open types such as semi-waffle pattern, semi-triangle or pentagon, semi-circular of oval shape. In addition, the lower discharge electrodes 132 having the above described structures can be disposed in the same plane within the plasma display panel and are separated from each other by a predetermined interval. The structures of the upper and lower discharge electrodes can be formed variously, thus these are not limited to the above example.

In one single sub-pixel, either the upper or lower discharge electrodes 131 and 132 functions as an address and sustain electrode, and the other functions as a scan and sustain electrode. For example, if the upper discharge electrode 131 functions as the address and sustain electrode, then the lower discharge electrode 132 functions as the scan and sustain electrode. Thus, when address voltage is applied to the upper discharge electrode 131 and scan voltage is applied to the lower discharge electrode 132, address discharge occurs at the sub-pixel 114 where the upper and lower discharge electrodes 131 and 132, to which the voltage are applied respectively, are commonly disposed. After the address discharge, when sustain voltage is alternately applied between the upper and lower discharge electrodes 131 and 132, the charged particles move vertically to generate the sustain discharge.

As shown in FIG. 4, the sustain discharge is concentrated at the upper portion of the sub-pixel 114, in the first barrier rib 112, and occurs perpendicularly to all side surfaces defining the sub-pixel 114. In addition, the sustain discharge occurring from the side surfaces of the sub-pixel 114 gradually diffuses from the perimeter to the center of the sub-pixel 114. Therefore, the discharge area becomes larger than the discharge area in a conventional panel, and since a volume of the area where the sustain discharge occurs increases, charge in the sub-pixel that was not used conventionally can contribute to the light emission. Accordingly, since the amount of plasma generated during the discharge can increase, the panel can be driven with low voltage. The discharge gas emits the ultraviolet rays according to the sustain discharge that occurs in the above mechanism, and the phosphor layer 123 disposed in the sub-pixel 114 is excited by the ultraviolet rays and emits visible lights.

The phosphor layer 123 emitting the visible light is formed of either red, green, or blue phosphor materials emitting red, green, or blue visible lights, and thus forming red, green, or blue phosphor layer, respectively. The sub-pixels 114 are divided into red, green, and blue sub-pixels according to the color of phosphor layers disposed at the sub-pixels 114. One each of the red, green, and blue sub-pixels are included in a unit pixel for representing various colors by combining the three primitive colors.

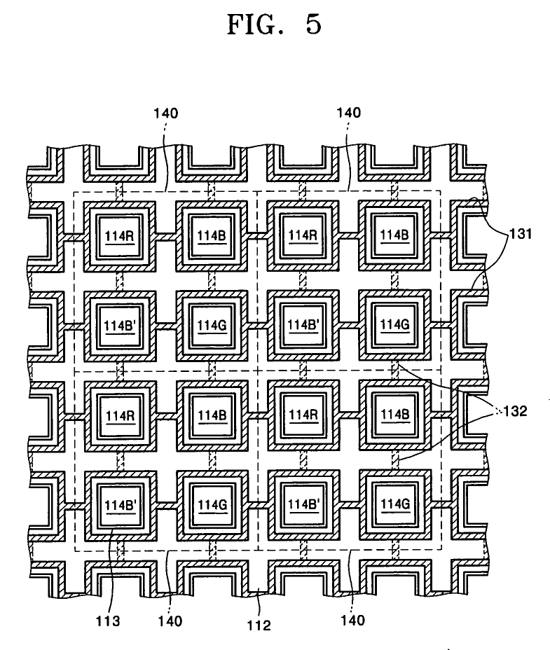

In the embodiment of this invention shown in FIG. 5, the unit pixel 140 representing various colors by combining the three primitive colors consists of four sub-pixels, including a sub-pixel emitting one of red, green, and blue lights in addition to the three conventional red, green, and blue sub-pixels 114R, 114G, and 114B.

The additional sub-pixel can be selected as sub-pixel that emits the light having the lowest maximum brightness level among the red, green, and blue lights. Since the sub-pixel emitting the light of the lowest maximum brightness level is included in the unit pixel 140, the maximum brightness of the light with the lowest maximum brightness level can be increased. Accordingly, color temperature of white light that is represented by mixing the red, green, and blue lights of maximum brightnesses can be increased, and the maximum brightness emitted by the unit pixel 140 can be increased. In addition, since the maximum brightness of the light having the lowest maximum brightness level becomes higher, the light can be more easily divided into plural gradations, and the gradation representing capacity can be improved.

As shown in FIG. 5, two blue sub-pixels 114B and 114B′ can be included in the unit pixel 140 when the blue light has the lowest maximum brightness. Accordingly, the maximum brightness of the blue light can be improved. Therefore, the color temperature of the white light represented by mixing the red, green, and blue lights of the maximum brightness can rise, and the maximum brightness of the light emitted by the unit pixel 140 can be maximized. The four sub-pixels 114R, 114G, 114B, and 114B′ forming the unit pixel 140 are arranged in two rows as shown in FIG. 5. However, the arrangement of the sub-pixels 114R, 114G, 114B, and 114B′ can be set in various arrangements and is not limited to the above example.

In the unit pixel 140 with four sub-pixels 114R, 114G, 114B, and 114B′, the blue phosphor layers disposed in the two blue sub-pixels 114B and 114B′ can have brightness and lifespan properties that are set to be different from each other.

Specifically, the phosphor layer disposed on one of the two blue sub-pixels 114B and 114B′ can be set to have relatively higher brightness property than the phosphor layer disposed on the other blue sub-pixel. In addition, the phosphor layer with the lower brightness property can be set to have longer life span property than the phosphor layer with the higher brightness. Accordingly, the phosphor layer with the higher brightness property is disposed on one of the two blue sub-pixels 114B and 114B′ while the phosphor layer with the lower brightness and longer life span property can be disposed on the other.

As described above, since the phosphor layer of higher brightness property is disposed on one of the two blue sub-pixels 114B and 114B′ forming the unit pixel 140 and the phosphor layer having longer life span property is disposed on the other, the maximum brightness of the blue light can be improved and brightness maintaining rate can be increased. Therefore, the color temperature property of the unit pixel 140 also can be improved.

The phosphor layer with the higher brightness property can be formed of a phosphor material such as BAM(BaMgAl₁₀O₁₇:Eu²⁺) that is known for having superior brightness property, and the phosphor layer having longer life span property can be formed of a phosphor material such as CMS(CaMgSi₂O₆:Eu²⁺) that is known for having higher life span property. In addition, the phosphor layer disposed on the red sub-pixel 114R forming the unit pixel 140 together with the blue sub-pixels 114B and 114B′ can be formed of Y(V,Gd)BO₃:Eu³⁺, and the phosphor layer disposed on the green sub-pixel 114G can be formed of Zn₂SiO₄:Mn²⁺.

As described above, according to the present invention, the unit pixel is formed to include four sub-pixels: red, green, and blue sub-pixels and a fourth sub-pixel selected as the sub-pixel with the lowest maximum brightness level. In addition, the phosphor layers disposed on the two sub-pixels having the lowest maximum brightness level included in the unit pixel are set to have different brightness and life span properties from each other. As a result of adding the fourth sub-pixel to the unit pixel, the color temperature and the brightness of the light emitted by the unit pixel can be improved and the life span of the panel can increase, thus improving the brightness level maintaining rate. In addition, the maximum brightness of the light having the lowest maximum brightness level can be increased, and gradation can be represented in detail.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
an upper substrate;
a lower substrate facing the upper substrate;
a plurality of barrier ribs formed between the upper substrate and lower substrate to define a red sub-pixel with a red phosphor, a green sub-pixel with a green phosphor, and a blue sub-pixel with a blue phosphor;
a plurality of upper discharge electrodes disposed in the plurality of barrier ribs to correspond to the sub-pixels;
a plurality of lower discharge electrodes disposed in the plurality of barrier ribs to correspond to the sub-pixels; and
a unit pixel that comprises a red sub-pixel, a green sub-pixel, a blue sub-pixel, and an additional sub-pixel of the color having a lowest maximum brightness level;
wherein the phosphor layers disposed on the two sub-pixels having the lowest maximum brightness level have different brightness and life span properties from each other.

2. The plasma display panel of claim 1, wherein the barrier ribs are formed of dielectric material, and the plurality of upper discharge electrodes and the plurality of lower discharge electrodes cross each other to form the sub-pixels.

3. The plasma display panel of claim 2, wherein the upper discharge electrodes comprise square units surrounding each sub-pixel and coupled together in a first plurality of square units, and the lower discharge electrodes comprise square units surrounding each sub-pixel and coupled together in a second plurality of square units.

4. The plasma display panel of claim 1, wherein the phosphor layer disposed on one of the two sub-pixels having a lowest maximum brightness level in the unit pixel has higher brightness property and shorter life span property than the phosphor layer disposed on the other sub-pixel between the two.

5. The plasma display panel of claim 4, wherein the sub-pixel having a lowest maximum brightness level is the blue sub-pixel.

6. The plasma display panel of claim 5, wherein the phosphor layer having higher brightness property among the two blue sub-pixels comprises BAM(BaMgAl₁₀O₁₇:Eu²⁺).

7. The plasma display panel of claim 5, wherein the phosphor layer having the longer life span property among the two blue sub-pixels comprises CMS(CaMgSi₂O₆:Eu²⁺).

8. The plasma display panel of claim 1, wherein the four sub-pixels forming the unit pixel are disposed in two rows and two columns.

9. The plasma display panel of claim 1, wherein the barrier ribs comprise first barrier ribs, in which the upper and lower discharge electrodes are disposed, and second barrier ribs formed under the first barrier ribs, on the surface of which the phosphor layers are disposed.

10. The plasma display panel of claim 1, wherein an MgO layer covers side surfaces of the barrier ribs.

11. The plasma display panel of claim 1, wherein the plurality of upper discharge electrodes and the plurality of lower discharge electrodes are formed of conductive metal.

12. A unit pixel, comprising:
a red sub-pixel;
a green sub-pixel;
a blue sub-pixel; and
an additional sub-pixel of the color having a lowest maximum brightness level;
wherein the phosphor layers disposed on the two sub-pixels having the lowest maximum brightness level have different brightness and life span properties from each other.

13. The unit pixel of claim 12, wherein said additional sub-pixel is a blue sub-pixel.

14. The plasma display panel of claim 1, wherein the barrier ribs comprise first barrier ribs, in which the upper discharge electrodes are disposed, and second barrier ribs under the first barrier ribs, in which the lower discharge electrodes are disposed.
